(19) United States
(12) Patent Application Publication
(10) Pub. No.: US 2026/0098577 A1
(43) Pub. Date: Apr. 9, 2026

(54) TRANSMISSION DEVICE

(71) Applicants: TOYOTA JIDOSHA KABUSHIKI KAISHA, Toyota-shi (JP); AISIN CORPORATION, Kariya (JP)

(72) Inventors: Yukihiro INABA, Nisshin-shi (JP); Sohei MURATA, Nisshin-shi (JP); Taiki OWARI, Kariya-shi (JP); Eiji KIDA, Kariya-shi (JP); Yasukuni OJIMA, Kariya-shi (JP)

(73) Assignees: TOYOTA JIDOSHA KABUSHIKI KAISHA, Toyota-shi (JP); AISIN CORPORATION, Kariya (JP)

(21) Appl. No.: 19/336,741

(22) Filed: Sep. 23, 2025

(30) Foreign Application Priority Data
Oct. 9, 2024 (JP) 2024-177208

(51) Int. Cl. F16H 61/00; F16H 3/54; F16H 57/02; F16H 57/037; F16H 63/04; F16H 63/30

(52) U.S. Cl. CPC F16H 61/0059; F16H 3/54; F16H 63/04; F16H 2057/02034; F16H 2057/02052; F16H 57/037; F16H 63/304; F16H 2063/3063; F16H 2200/0021; F16H 2200/0034; F16H 2200/2005; F16H 2200/2094

(57) ABSTRACT

A transmission device includes a planetary gear mechanism, a case housing the planetary gear mechanism, a coupling part supported so as to be able to relatively shift with respect to the case, and a moving mechanism that moves the coupling part among first to third positions. Of the sun gear, the ring gear, and the carrier, one is an input-side rotating body, another is an output-side rotating body, and the other one is an intermediate rotating body. The case is provided with a first engaging part that can be engaged with the coupling part. One of the input-side rotating body and the output-side rotating body is provided with a second engaging part that can be engaged with the coupling part. The intermediate rotating body is provided with a third engaging part that can be engaged with the coupling part.

### CROSS-REFERENCE TO RELATED APPLICATION

This application claims priority to Japanese Patent Application No. 2024-177208 filed on Oct. 9, 2024. The disclosure of the above-identified application, including the specification, drawings, and claims, is incorporated by reference herein in its entirety.

### BACKGROUND

### 1. Technical Field

The technology disclosed by this specification relates to a transmission device.

### 2. Description of Related Art

Japanese Unexamined Patent Application Publication No. 2012-2353 (JP 2012-2353 A) discloses contents that realize a parking lock mechanism in a transmission device using a planetary gear mechanism by putting the transmission device in an interlocked state.

### SUMMARY

Putting the transmission device of JP 2012-2353 A in the interlocked state requires an engaging mechanism that controls engaging elements. One problem is that the increase in the number of parts leads to an increase in the cost as well as the weight.

A transmission device disclosed by this specification is disposed between an input shaft and an output shaft. The transmission device includes: a planetary gear mechanism having a sun gear, a ring gear, a carrier, and a pinion gear; a case housing the planetary gear mechanism; a coupling part supported so as to be able to relatively shift with respect to the case; and a moving mechanism configured to be able to move the coupling part among a first position, a second position, and a third position. One of the sun gear, the ring gear, and the carrier is an input-side rotating body that is connected to the input shaft. Another of the sun gear, the ring gear, and the carrier is an output-side rotating body that is connected to the output shaft. The other one of the sun gear, the ring gear, and the carrier is an intermediate rotating body. The case is provided with a first engaging part that is able to be engaged with and disengaged from the coupling part. One of the input-side rotating body and the output-side rotating body is provided with a second engaging part that is able to be engaged with and disengaged from the coupling part. The intermediate rotating body is provided with a third engaging part that is able to be engaged with and disengaged from the coupling part. When the coupling part is in the first position, the coupling part engages the first engaging part and the third engaging part with each other. When the coupling part is in the second position, the coupling part engages the second engaging part and the third engaging part with each other. When the coupling part is in the third position, the coupling part engages the first engaging part, the second engaging part, and the third engaging part with one another.

In this configuration, when the coupling part is in the first position, the input-side rotating body and the output-side rotating body can rotate. Therefore, the rotation of the input shaft is output to the output shaft after the number of rotations is converted by the planetary gear mechanism. When the coupling part is in the second position, the input-side rotating body, the intermediate rotating body, and the output-side rotating body can rotate integrally. Therefore, the rotation of the input shaft is output to the output shaft without the number of rotations being converted by the planetary gear mechanism. When the coupling part is in the third position, relative rotation with respect to the case of either the input-side rotating body or the output-side rotating body, and the intermediate rotating body is prohibited. Since two rotating bodies among the three rotating bodies included in the planetary gear mechanism can be restrained from rotating, the rotation of the planetary gear mechanism can be mechanically locked. An interlocked state can be realized using the coupling part for realizing a transmission mechanism, which eliminates the need for separately including a new engaging mechanism. This makes it possible to provide the transmission device with a parking lock mechanism while avoiding an increase in cost as well as weight due to an increase in the number of parts.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a skeleton diagram showing a schematic configuration of a drive device 1;

FIG. 2 is a view schematically showing engaged states;

FIG. 3 is a view schematically showing a first modified example of the engaged states;

FIG. 4 is a view schematically showing a second modified example of the engaged states;

FIG. 5 is a view schematically showing engaged states in Example of Implementation 2; and

FIG. 6 is a view schematically showing a modified example of the engaged states in Example of Implementation 2.

### DETAILED DESCRIPTION OF EMBODIMENTS

One of the sun gear and the carrier may be the input-side rotating body. The other one of the sun gear and the carrier may be the output-side rotating body. The ring gear may be the intermediate rotating body.

In this configuration, when the sun gear is the input-side rotating body and the carrier is the output-side rotating body, a speed reducing mechanism can be realized when the coupling part is in the first position. When the carrier is the input-side rotating body and the sun gear is the output-side rotating body, a speed increasing mechanism can be realized when the coupling part is in the first position.

The second engaging part may be disposed on the carrier and located coaxially with the ring gear. The third engaging part may be disposed on an outer circumference of the ring gear. The coupling part may include a sleeve that is disposed so as to be slidable in a rotational axis direction of the planetary gear mechanism. The sleeve may be configured to be able to be engaged with each of the first engaging part, the second engaging part, and the third engaging part.

In this configuration, an operation state of the planetary gear mechanism can be switched by the sleeve.

The first engaging part may be located coaxially with the ring gear. The sleeve may include an inner circumferential spline that is provided on an inner circumference. When the sleeve is in the first position, the inner circumferential spline may be engaged with the first engaging part and the third engaging part and may not be engaged with the second engaging part. When the sleeve is in the second position, the inner circumferential spline may be engaged with the second engaging part and the third engaging part and may not be engaged with the first engaging part. When the sleeve is in the third position, the inner circumferential spline may be engaged with the first engaging part, the second engaging part, and the third engaging part.

The first engaging part may be disposed at a position on a radially outer side of the ring gear. The sleeve may include an inner circumferential spline provided on an inner circumference of the sleeve and an outer circumferential spline provided on an outer circumference of the sleeve. When the sleeve is in the first position, the inner circumferential spline may be engaged with the third engaging part and the outer circumferential spline may be engaged with the first engaging part, and the sleeve may not be engaged with the second engaging part. When the sleeve is in the second position, the inner circumferential spline may be engaged with the second engaging part and the third engaging part, and the sleeve may not be engaged with the first engaging part. When the sleeve is in the third position, the inner circumferential spline may be engaged with the second engaging part and the third engaging part, and the outer circumferential spline may be engaged with the first engaging part.

### Example of Implementation 1

### Configuration of Drive Device 1

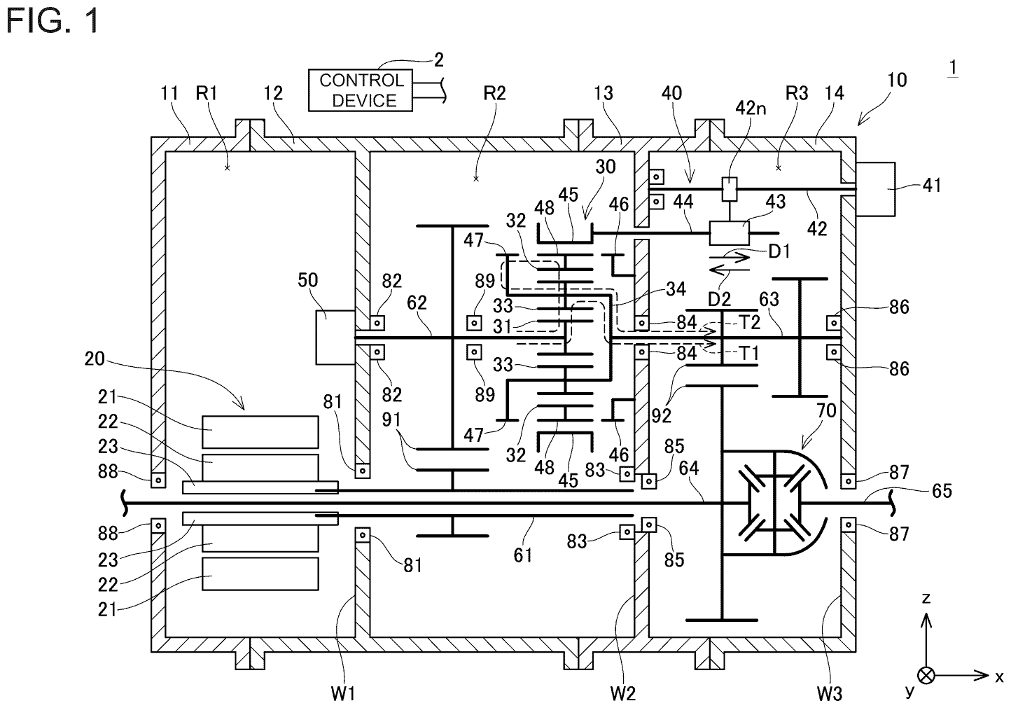

FIG. 1 is a skeleton diagram for describing the structure of a drive device 1 of a battery electric vehicle. The drive device 1 is a device that drives a pair of right and left wheels (not shown) of the vehicle. The drive device 1 may be an integral device having a motor, a gear unit, and a power conversion unit for controlling the motor all housed in the same casing. In FIG. 1, axial directions of a first shaft 61, a second shaft 62, a ring gear 32, a third shaft 63, a first output shaft 64, and a second output shaft 65 are an x-direction. A case 10 is shown in a sectional view and components of the case 10 are hatched. The same applies to the subsequent drawings.

The drive device 1 is controlled by a control device 2. The control device 2 includes a CPU, an RAM, an ROM, an input-output interface, etc. The control device 2 is connected to a motor 20, an actuator 41, etc. by signal lines (not shown).

The drive device 1 mainly includes the case 10, the motor 20, a planetary gear mechanism 30, a transmission mechanism 40, an oil pump 50, the first shaft 61, the second shaft 62, the third shaft 63, the first output shaft 64, the second output shaft 65, and a differential gear 70.

The case 10 has a structure in which a motor cover 11, a center case 12, an intermediate case 13, and a gear cover 14 are disposed next to one another in the x-direction. These cases may be castings. These four members are fastened together to form the case 10. The case 10 includes a first room R1, a second room R2, and a third room R3. The first room, the second room, and the third room are arranged in this order along the axial direction of the first shaft 61 (i.e., the x-direction). The case 10 includes a first wall W1, a second wall W2, and a third wall W3. The first wall W1 separates the first room R1 and the second room R2 from each other. The second wall W2 separates the second room R2 and the third room R3 from each other. The third wall W3 demarcates the third room R3 between itself and the second wall W2.

In the first wall W1, a bearing 81 and a bearing 82 are provided. The bearing 81 rotatably supports the first shaft 61. The bearing 82 rotatably supports the second shaft 62. In the second wall W2, a bearing 83, a bearing 84, and a bearing 85 are provided. The bearing 83 rotatably supports the first shaft 61. The bearing 84 rotatably supports the third shaft 63. The bearing 85 rotatably supports the first output shaft 64. In the third wall W3, a bearing 86 and a bearing 87 are provided. The bearing 86 rotatably supports the third shaft 63. The bearing 87 rotatably supports the second output shaft 65.

An advantage will be described. The first wall W1, the second wall W2, and the third wall W3 include various bearings. Thus, three assemblies of an assembly having the first wall W1, an assembly having the second wall W2, and an assembly having the third wall W3 can be assembled in advance. Then, in a final assembly step, it is only necessary to assemble these three assemblies. This can simplify an assembly step of the drive device 1.

The first room R1 mainly houses the motor 20 and the oil pump 50. The motor 20 includes a stator 21, a rotor 22, and a motor shaft 23. The stator 21 has a cylindrical shape. The rotor 22 is rotatably disposed inside the stator 21. The motor shaft 23 is fixed on the rotor 22.

The second room R2 mainly houses the first shaft 61, the second shaft 62, a first gear pair 91, the planetary gear mechanism 30, and part of the transmission mechanism 40. The first shaft 61 is coaxially connected to the motor shaft 23. The first shaft and the motor shaft 23 have a hollow structure. The first shaft 61 is supported by the bearings 81, 83. The first shaft 61 is driven by the motor 20.

The second shaft 62 is disposed parallel to the first shaft 61. The second shaft 62 is supported by the bearings 82, 89. The first shaft 61 and the second shaft 62 are coupled together by the first gear pair 91. A drive force of the first shaft 61 is transmitted to the second shaft 62.

The planetary gear mechanism 30 includes a sun gear 31, the ring gear 32, a pinion gear 33, and a carrier 34. The sun gear 31 is disposed at an end portion of the second shaft 62 in a +x-direction. The sun gear 31 is mechanically connected to the motor shaft 23 through the first gear pair 91 and the first shaft 61. Thus, the planetary gear mechanism 30 has the sun gear 31 for input and the carrier 34 for output.

An end portion of the second shaft 62 in a −x-direction is connected to the oil pump 50. The oil pump 50 is thereby mechanically connected to the sun gear 31. The oil pump 50 is a part that circulates oil inside the case 10. The oil pump 50 is a mechanical pump and is driven in conjunction with rotation of the sun gear 31. Thus, a circulation amount of the oil can be increased in conjunction with an increase in a rotation speed of the sun gear 31. This can effectively prevent occurrence of seizure and occurrence of wear in various gears inside the case 10.

The third room R3 mainly houses the third shaft 63, a second gear pair 92, the differential gear 70, the first output shaft 64, the second output shaft 65, and part of the transmission mechanism 40. The third shaft 63 is disposed coaxially with the second shaft 62. The third shaft 63 is supported by the bearings 84, 86. An end portion of the third shaft 63 in the −x-direction is connected to the carrier 34. A drive force output from the planetary gear mechanism 30 is transmitted to the third shaft 63. The third shaft 63 is coupled to the differential gear 70 by the second gear pair 92. The second gear pair 92 is a gear pair composed of a parallel gear disposed on the third shaft 63 and a ring gear included in the differential gear 70.

The differential gear 70 is a mechanism that distributes a drive force transmitted from the third shaft 63 to the first output shaft 64 and the second output shaft 65 that constitute a right-left pair. The first output shaft 64 and the second output shaft 65 are disposed coaxially with each other. The first output shaft 64 and the second output shaft 65 are shafts that output the drive force to a pair of tires (not shown).

The first output shaft 64 is supported by the bearings 85, 88. An end portion of the first output shaft 64 in the +x-direction is coupled to the differential gear 70. An end portion of the first output shaft 64 in the −x-direction penetrates the first shaft 61. Thus, a space to dispose the first output shaft 64 can be reduced and thereby the size of the drive device 1 can be reduced.

The second output shaft 65 is supported by the bearing 87. An end portion of the second output shaft 65 in the −x-direction is coupled to the differential gear 70.

### Configuration of Transmission Mechanism 40

The transmission mechanism 40 mainly includes the actuator 41, a ball screw 42, an urging part 43, a shift fork 44, a sleeve 45, a first ring part 46, a second ring part 47, and a ring gear hub 48. The first ring part 46 is located coaxially with the ring gear 32 and disposed on the second wall W2. The second ring part 47 is located coaxially with the ring gear 32 and disposed on the carrier 34. The ring gear hub 48 is located coaxially with the ring gear 32 and fixed on an outer circumference of the ring gear 32. The sleeve 45 is disposed so as to be slidable in the axial direction of the ring gear 32 (i.e., the x-direction).

In this example of implementation, the sun gear 31 corresponds to the input-side rotating body that is connected to the input shaft. The carrier 34 corresponds to the output-side rotating body that is connected to the output shaft. The ring gear 32 corresponds to the intermediate rotating body. Therefore, the first ring part 46 corresponds to the first engaging part that is provided on the case 10. The second ring part 47 corresponds to the second engaging part that is provided on the output-side rotating body. The ring gear hub 48 corresponds to the third engaging part that is provided on the intermediate rotating body.

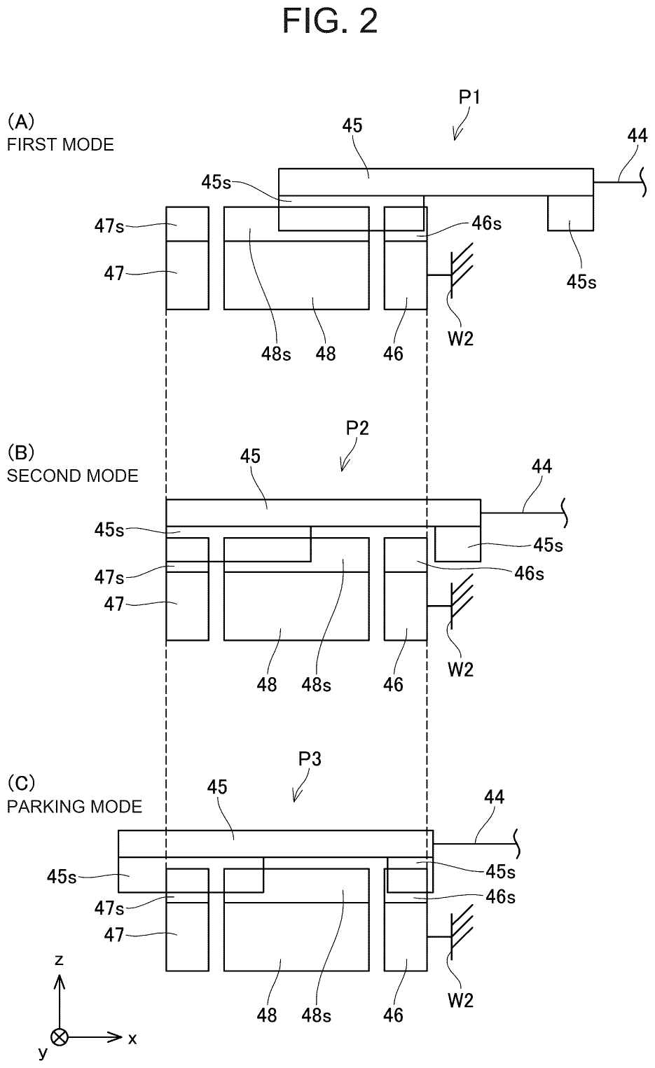

FIG. 2 schematically shows engaged states of the sleeve 45, the first ring part 46, the second ring part 47, and the ring gear hub 48. On outer circumferences of the first ring part 46, the second ring part 47, and the ring gear hub 48, splines 46s, 47s, 48s, respectively, are formed. On an inner circumference of the sleeve 45, an inner circumferential spline 45s is formed. The inner circumferential spline 45s is configured to be able to be engaged with the splines 46s, 47s, 48s respectively of the first ring part 46, the second ring part 47, and the ring gear hub 48. The inner circumferential spline 45s includes such a tooth shape that it can fit on two of the splines 46s, 47s, 48s at the same time as well as can fit on the three of them at the same time.

The actuator 41 is a rotational actuator. In this example of implementation, the actuator 41 is a motor. The ball screw 42 is a linear motion mechanism that converts a rotary motion output by the actuator 41 into a linear motion. A nut 42n of the ball screw 42 is coupled to the shift fork 44 through the urging part 43. An end portion of the shift fork 44 in the −x-direction is connected to the sleeve 45. The shift fork 44 is a part that transmits the linear motion output by the ball screw 42 to the sleeve 45. The shift fork 44 is configured to be able to move in a first direction D1 and a second direction D2 along the axial direction of the ring gear 32. The first direction D1 is a direction away from the ring gear 32 (i.e., the +x-direction). The second direction D2 is a direction toward the ring gear 32 (i.e., the −x-direction).

The urging part 43 includes a spring (not shown) and applies an urging force in the axial direction of the ring gear to the shift fork 44. The urging part 43 applies an urging force in the first direction D1 to the shift fork 44 when the shift fork moves in the first direction D1. The urging part 43 applies an urging force in the second direction D2 to the shift fork 44 when the shift fork moves in the second direction D2. A specific structure for realizing the function of the urging part 43 is commonly known and therefore a detailed description thereof will be omitted.

### Operation of Transmission Mechanism 40

The transmission mechanism 40 is a mechanism that can switch an operation mode of the planetary gear mechanism 30 among a first mode, a second mode, and a parking mode. In the first mode, rotation of the motor 20 is transmitted to the output shaft after the speed thereof is reduced. In the second mode, the rotation of the motor 20 is transmitted to the output shaft without the speed thereof being reduced. In the parking mode, rotation of the planetary gear mechanism 30 is mechanically locked. Switching of the operation mode is performed by moving the sleeve 45 among a first position P1, a second position P2, and a third position P3. This will be described below.

The first mode will be described using FIG. 2 (A). In the first mode, the sleeve 45 is in the first position P1. In the first position P1, the sleeve 45 is engaged with the ring gear hub 48 and the first ring part 46 and is not engaged with the second ring part 47. The ring gear 32 is coupled to the case 10 so as to be incapable of relative rotation, and the ring gear 32 is uncoupled from the carrier 34. Thus, in the first mode, relative rotation of the ring gear 32 with respect to the case 10 is prohibited, and relative rotation of the ring gear 32 with respect to the carrier 34 is permitted. Accordingly, the carrier 34 can rotate around a central axis of the sun gear 31. Therefore, rotation of the first shaft 61 is transmitted to the carrier 34 through the sun gear 31 and the pinion gear 33. (See a transmission path T1 indicated by the dashed arrow in FIG. 1). Thus, the planetary gear mechanism 30 functions as a speed reducer.

The second mode will be described using FIG. 2 (B). In the second mode, the sleeve 45 is in the second position P2. In the second position P2, the sleeve 45 is engaged with the ring gear hub 48 and the second ring part 47 and is not engaged with the first ring part 46. The ring gear 32 is coupled to the carrier 34 so as to be incapable of relative rotation, and the ring gear 32 is uncoupled from the case 10. Thus, in the second mode, relative rotation of the ring gear 32 with respect to the carrier 34 is prohibited, and relative rotation of the ring gear 32 with respect to the case 10 is permitted. Accordingly, the carrier 34 and the ring gear 32 rotate integrally with the sun gear 31. Therefore, rotation of the first shaft 61 is transmitted to the carrier 34 through the sun gear 31, the pinion gear 33, the ring gear 32, the ring gear hub 48, the sleeve 45, and the second ring part 47. (See a transmission path T2 indicated by the dashed arrow in FIG. 1). Thus, the planetary gear mechanism 30 docs not function as a speed reducer.

The parking mode will be described using FIG. 2 (C). In the parking mode, the sleeve 45 is in the third position P3. In the third position P3, the sleeve 45 engages the first ring part 46, the second ring part 47, and the ring gear hub 48 with each other. Relative rotation with respect to the case 10 of the carrier 34 that is the output-side rotating body and the ring gear hub 48 that is the intermediate rotating body is prohibited. Since two rotating bodies among the three rotating bodies included in the planetary gear mechanism 30 can be restrained from rotating, rotation of the planetary gear mechanism 30 can be mechanically locked. Thus, the planetary gear mechanism 30 functions as a parking mechanism.

### Advantages

In the technology of this specification, the shape of the inner circumferential spline 45s of the sleeve 45 can be appropriately arranged so as to provide the one transmission mechanism 40 with two travel modes and a parking function. Thus, an interlocked state can be realized using the sleeve 45 for realizing the transmission mechanism 40, which eliminates the need for separately including a new engaging mechanism to realize the parking mechanism. This makes it possible to provide the transmission mechanism 40 with a parking mechanism while avoiding an increase in cost as well as weight due to an increase in the number of parts.

### Modified Example of Example of Implementation 1

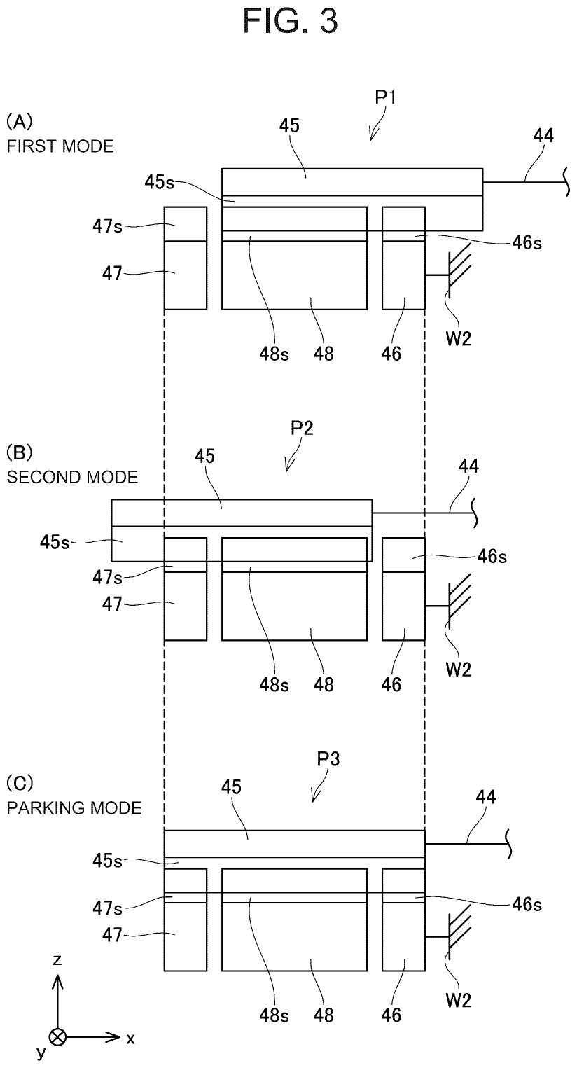

The tooth shape of the inner circumferential spline 45s of the sleeve 45 and the first position P1, the second position P2, and the third position P3 can be varied. FIG. 3 shows a first modified example. In the example of FIG. 3, the sleeve 45 includes such a tooth shape that the inner circumferential spline 45s is disposed on the entire sleeve 45 in the axial direction (x-direction). This tooth shape also allows execution of switching among the first mode of FIG. 3 (A), the second mode of FIG. 3 (B), and the parking mode of FIG. 3 (C).

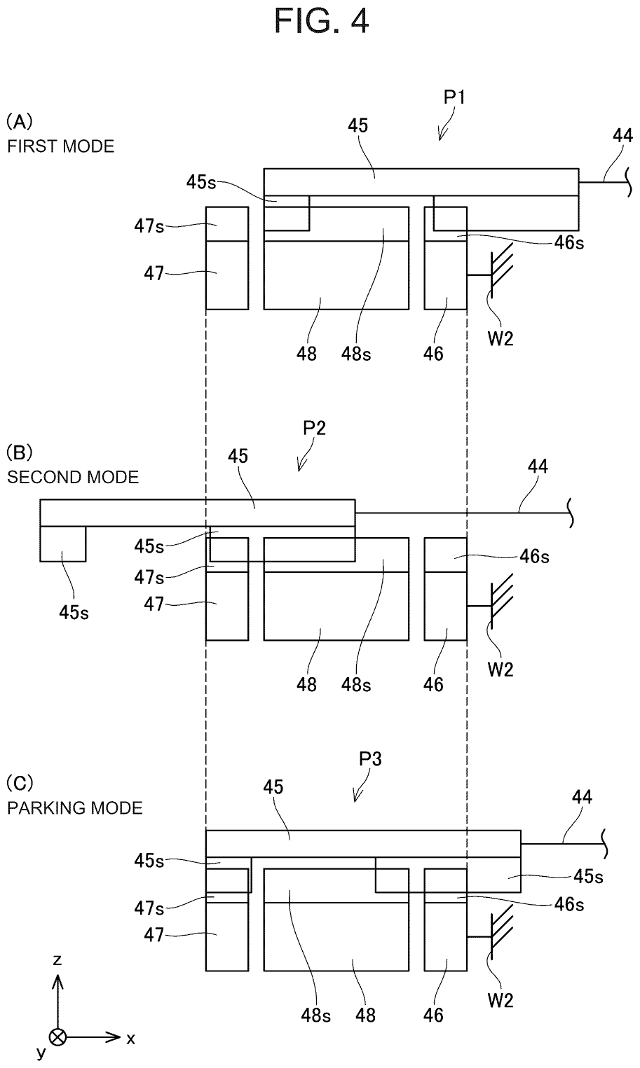

FIG. 4 shows a second modified example. In the example of FIG. 4, the sleeve 45 includes a tooth shape that is a mirror image of that of the sleeve 45 of FIG. 2 with respect to the axial direction. This tooth shape also allows execution of switching among the first mode of FIG. 4 (A), the second mode of FIG. 4 (B), and the parking mode of FIG. 4 (C).

### Example of Implementation 2

In Example of Implementation 2, the sleeve 45 and the first ring part 46 have different aspects from those in Example of Implementation 1. In the following, only differences from Example of Implementation 1 will be described.

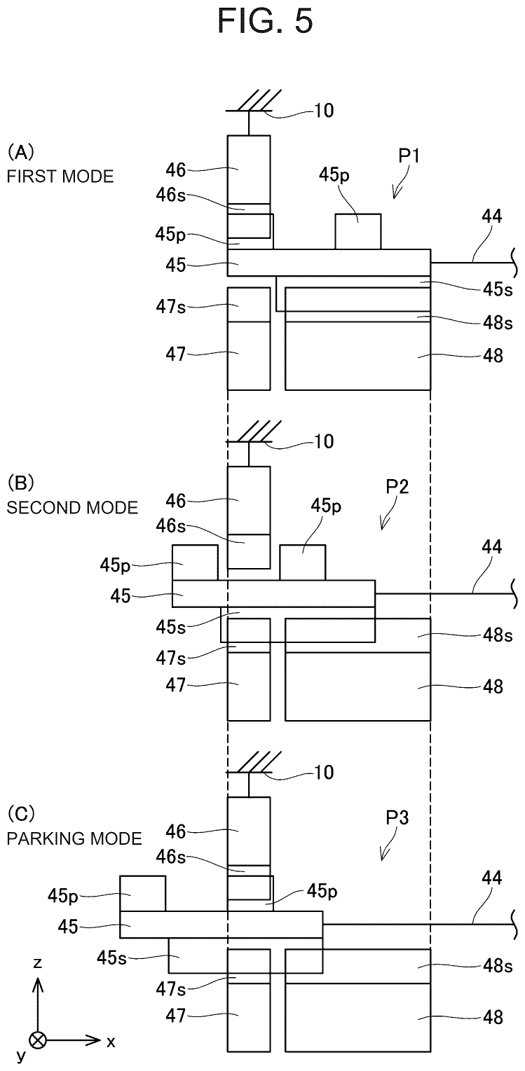

FIG. 5 schematically shows engaged states of the sleeve 45, the first ring part 46, the second ring part 47, and the ring gear hub 48. FIG. 5 is a drawing similar to FIG. 2. The first ring part 46 is disposed on a radially outer side (i.e., a +z-direction side) with respect to the ring gear 32. The first ring part 46 is fixed on the case 10. On the first ring part 46, a spline 46s is disposed at a position facing the sleeve 45. In addition to the inner circumferential spline 45s formed on the inner circumference, the sleeve 45 further includes an outer circumferential spline 45p that is formed on an outer circumference thereof.

The first mode will be described using FIG. 5 (A). In the first mode, the sleeve 45 is in the first position P1. In the first position P1, the inner circumferential spline 45s of the sleeve 45 is engaged with the spline 48s of the ring gear hub 48, and the outer circumferential spline 45p of the sleeve 45 is engaged with the spline 46s of the first ring part 46. The sleeve 45 is not engaged with the spline 47s of the second ring part 47.

The second mode will be described using FIG. 5 (B). In the second mode, the sleeve 45 is in the second position P2. In the second position P2, the inner circumferential spline 45s of the sleeve 45 is engaged with the spline 47s of the second ring part 47 and the spline 48s of the ring gear hub 48. The sleeve 45 is not engaged with the spline 46s of the first ring part 46.

The parking mode will be described using FIG. 5 (C). In the parking mode, the sleeve 45 is in the third position P3. In the third position P3, the inner circumferential spline 45s of the sleeve 45 is engaged with the spline 47s of the second ring part 47 and the spline 48s of the ring gear hub 48. The outer circumferential spline 45p of the sleeve 45 is engaged with the spline 46s of the first ring part 46.

### Modified Example of Example of Implementation 2

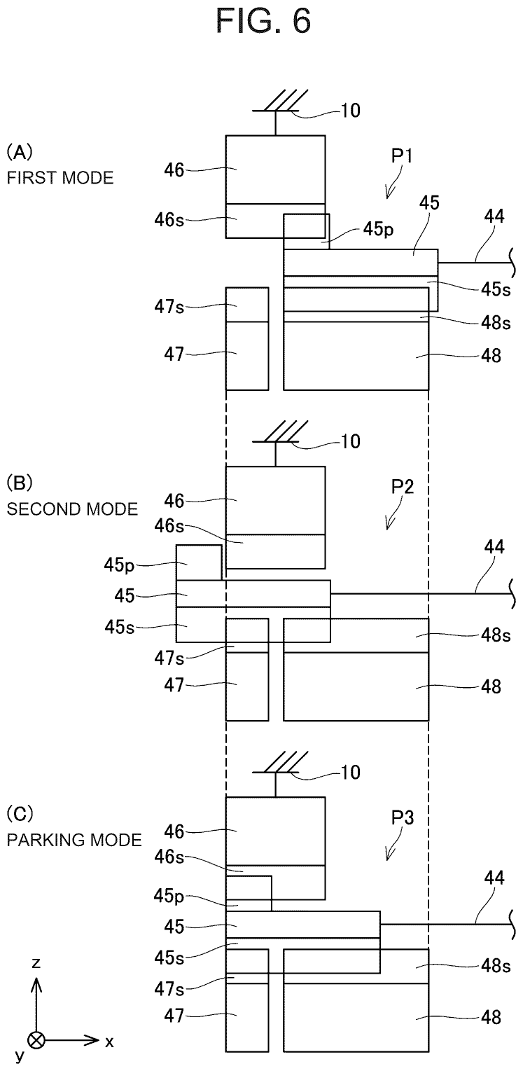

In Example of Implementation 2, too, the tooth shapes of the inner circumferential spline 45s and the outer circumferential spline 45p of the sleeve 45 can be varied. FIG. 6 shows a modified example. In the example of FIG. 6, the sleeve 45 includes such a tooth shape that the inner circumferential spline 45s is disposed on the entire sleeve 45 in the axial direction (x-direction). This tooth shape also allows execution of switching among the first mode of FIG. 6 (A), the second mode of FIG. 6 (B), and the parking mode of FIG. 6 (C).

While embodiments have been described in detail above, these are merely illustration and do not limit the claims. The technology described in the claims include the above-illustrated specific examples to which various modifications and changes have been made. The technical elements described in this specification or the drawings exhibit technical utility independently or in various combinations, and are not limited to the combinations described in the claims as filed. In addition, the technology illustrated in this specification or the drawings achieves a plurality of objects at the same time, and its achieving one of these objects in itself means that it has technical utility.

### MODIFIED EXAMPLES

While in this specification the case has been described in which the sun gear 31 is the input-side rotating body, the carrier 34 is the output-side rotating body, and the ring gear 32 is the intermediate rotating body, the present disclosure is not limited to this form. For example, when the carrier 34 is the input-side rotating body, the sun gear 31 is the output-side rotating body, and the ring gear 32 is the intermediate rotating body, a speed increasing mechanism can be realized when the sleeve 45 is in the first position P1. Further, for example, when the ring gear 32 is the input-side rotating body, the carrier 34 is the output-side rotating body, and the sun gear 31 is the intermediate rotating body, a speed reducing mechanism can be realized when the sleeve 45 is in the first position P1. Moreover, for example, when the carrier 34 is the input-side rotating body, the ring gear 32 is the output-side rotating body, and the sun gear 31 is the intermediate rotating body, a speed increasing mechanism can be realized when the sleeve 45 is in the first position P1.

The drive device 1 may have a form in which only either the first output shaft 64 or the second output shaft 65 is provided. In this case, the need for the differential gear 70 can be eliminated.

While in this specification the sleeve 45 has been described as one example of the coupling part, the present disclosure is not limited to this form. The coupling part may be a pin, a ball, or the like.

The vehicle in which the drive device of this specification is installed is not limited to a battery electric vehicle. The drive device of this specification can be installed in, for example, a hybrid electric vehicle or a plug-in hybrid electric vehicle. In this case, the drive device of this specification may house a plurality of motors or the planetary gear mechanism inside a casing. Further, the drive device of this specification is also applicable to a vehicle that uses an electric motor for at least part of traveling, such as a fuel cell electric vehicle.

The transmission mechanism 40 is one example of the moving mechanism. The sleeve 45 is one example of the coupling part.

What is claimed is:

1. A transmission device disposed between an input shaft and an output shaft, the transmission device comprising:
a planetary gear mechanism having a sun gear, a ring gear, a carrier, and a pinion gear;
a case housing the planetary gear mechanism;
a coupling part supported so as to be able to relatively shift with respect to the case; and
a moving mechanism configured to be able to move the coupling part among a first position, a second position, and a third position, wherein:
one of the sun gear, the ring gear, and the carrier is an input-side rotating body that is connected to the input shaft;
another of the sun gear, the ring gear, and the carrier is an output-side rotating body that is connected to the output shaft;
the other one of the sun gear, the ring gear, and the carrier is an intermediate rotating body;
the case is provided with a first engaging part that is able to be engaged with and disengaged from the coupling part;
one of the input-side rotating body and the output-side rotating body is provided with a second engaging part that is able to be engaged with and disengaged from the coupling part;
the intermediate rotating body is provided with a third engaging part that is able to be engaged with and disengaged from the coupling part;
when the coupling part is in the first position, the coupling part engages the first engaging part and the third engaging part with each other;
when the coupling part is in the second position, the coupling part engages the second engaging part and the third engaging part with each other; and
when the coupling part is in the third position, the coupling part engages the first engaging part, the second engaging part, and the third engaging part with one another.

2. The transmission device according to claim 1, wherein:
one of the sun gear and the carrier is the input-side rotating body;
the other one of the sun gear and the carrier is the output-side rotating body; and
the ring gear is the intermediate rotating body.

3. The transmission device according to claim 2, wherein:
the second engaging part is disposed on the carrier and located coaxially with the ring gear;
the third engaging part is disposed on an outer circumference of the ring gear;
the coupling part includes a sleeve that is disposed so as to be slidable in a rotational axis direction of the planetary gear mechanism; and
the sleeve is configured to be able to be engaged with each of the first engaging part, the second engaging part, and the third engaging part.

4. The transmission device according to claim 3, wherein:
the first engaging part is located coaxially with the ring gear;
the sleeve includes an inner circumferential spline that is provided on an inner circumference;
when the sleeve is in the first position, the inner circumferential spline is engaged with the first engaging part and the third engaging part and is not engaged with the second engaging part;
when the sleeve is in the second position, the inner circumferential spline is engaged with the second engaging part and the third engaging part and is not engaged with the first engaging part; and
when the sleeve is in the third position, the inner circumferential spline is engaged with the first engaging part, the second engaging part, and the third engaging part.

5. The transmission device according to claim 3, wherein:
the first engaging part is disposed at a position on a radially outer side of the ring gear;
the sleeve includes an inner circumferential spline provided on an inner circumference of the sleeve and an outer circumferential spline provided on an outer circumference of the sleeve;
when the sleeve is in the first position, the inner circumferential spline is engaged with the third engaging part and the outer circumferential spline is engaged with the first engaging part, and the sleeve is not engaged with the second engaging part;
when the sleeve is in the second position, the inner circumferential spline is engaged with the second engaging part and the third engaging part, and the sleeve is not engaged with the first engaging part; and
when the sleeve is in the third position, the inner circumferential spline is engaged with the second engaging part and the third engaging part, and the outer circumferential spline is engaged with the first engaging part.
